(19) United States
(12) Patent Application Publication
(10) Pub. No.: US 2025/0048113 A1
(43) Pub. Date: Feb. 6, 2025

(54) SUCI ENCRYPTION

(71) Applicant: Nokia Technologies Oy, Espoo (FI)

(72) Inventors: Aritra BANERJEE, Munich (DE); Ranganathan MAVUREDDI DHANASEKARAN, Munich (DE); K TIRUMALESWAR REDDY, Bangalore (IN); Saurabh KHARE, Bangalore (IN)

(21) Appl. No.: 18/791,362

(22) Filed: Jul. 31, 2024

(30) Foreign Application Priority Data
Aug. 4, 2023 (IN) 202311052637

(51) Int. Cl. H04W 12/72; H04L 9/30

(52) U.S. Cl. CPC H04W 12/72; H04L 9/3066

(57) ABSTRACT

Embodiments of the present disclosure relate to subscription concealed identifier (SUCI) encryption. In an aspect, a terminal device generates a SUCI of the terminal device based on a subscription permanent identifier (SUPI) of the terminal device. The SUCI comprises a SUPI type indicating that both elliptic curve cryptography (ECC) and post quantum cryptography (PQC) are used in the generating of the SUCI. The terminal device further transmits the SUCI to a network device. As such, a SUCI can be defined to comprise a SUPI type indicating that both the ECC and PQC are used in the generating of the SUCI. With the SUCI generated based on both the ECC and PQC, different kinds of cryptanalytic attacks can be avoided.

### FIELD

Various example embodiments relate to the field of communications and in particular, to devices, methods, apparatuses and a computer readable storage medium for subscription concealed identifier (SUCI) encryption.

### BACKGROUND

A SUPI is a 5G globally unique subscription permanent identifier (SUPI) allocated to each subscriber as defined in 3GPP specification TS 23.501. A SUCI is a privacy preserving identifier containing the concealed SUPI for communication security. Traditionally, the concealment of the SUPI is based on an elliptic curve integrated encryption scheme (ECIES) which generates the SUCI based on an elliptic curve cryptography (ECC) ephemeral public and private key pair and a provisioned public key of a home network for user equipment (UE). However, there are still challenges in how to ensure communication security by using the ECIES-based SUCI encryption. For example, the ECIES-based SUCI encryption will fall to quantum cryptanalysis.

### SUMMARY

In general, example embodiments of the present disclosure provide a solution for SUCI encryption.

In a first aspect, there is provided a terminal device. The terminal device comprises at least one processor and at least one memory storing instructions that, when executed by the at least one processor, cause the terminal device at least to: generate, a subscription concealed identifier, SUCI, of the terminal device based on a subscription permanent identifier, SUPI, of the terminal device, wherein the SUCI comprises a SUPI type indicating that both elliptic curve cryptography, ECC, and post quantum cryptography, PQC are used in the generating of the SUCI; and transmit, to a network device, the SUCI.

In a second aspect, there is provided a network device. The network device comprises at least one processor and at least one memory storing instructions that, when executed by the at least one processor, cause the network device at least to: receive, from a terminal device, a subscription concealed identifier, SUCI, for concealing a subscription permanent identifier, SUPI, for the terminal device, wherein the SUCI comprises a SUPI type indicating that both elliptic curve cryptography, ECC, and post quantum cryptography, PQC are used in generating of the SUCI; and determine the SUPI by decrypting the SUCI.

In a third aspect, there is provided a method. The method comprises generating, at a terminal device, a subscription concealed identifier, SUCI, of the terminal device based on a subscription permanent identifier, SUPI, of the terminal device, wherein the SUCI comprises a SUPI type indicating that both elliptic curve cryptography, ECC, and post quantum cryptography, PQC are used in the generating of the SUCI; and transmitting, from the terminal device, the SUCI to a network device.

In a fourth aspect, there is provided a method. The method comprises receiving, at a network device and from a terminal device, a subscription concealed identifier, SUCI, for concealing a subscription permanent identifier, SUPI, for the terminal device, wherein the SUCI comprises a SUPI type indicating that both elliptic curve cryptography, ECC, and post quantum cryptography, PQC are used in generating of the SUCI; and determining, at the network device, the SUPI by decrypting the SUCI.

In a fifth aspect, there is provided an apparatus comprising: means for generating, at a terminal device, a subscription concealed identifier, SUCI, of the terminal device based on a subscription permanent identifier, SUPI, of the terminal device, wherein the SUCI comprises a SUPI type indicating that both elliptic curve cryptography, ECC, and post quantum cryptography, PQC are used in the generating of the SUCI; and means for transmitting, from the terminal device, the SUCI to a network device.

In a sixth aspect, there is provided an apparatus comprising: means for receiving, at a network device and from a terminal device, a subscription concealed identifier, SUCI, for concealing a subscription permanent identifier, SUPI, for the terminal device, wherein the SUCI comprises a SUPI type indicating that both elliptic curve cryptography, ECC, and post quantum cryptography, PQC are used in generating of the SUCI; and means for determining, at the network device, the SUPI by decrypting the SUCI.

In a seventh aspect, there is provided a non-transitory computer readable medium comprising program instructions for causing an apparatus to perform at least the method according to any one of the above third and fourth aspects.

In an eighth aspect, there is provided a computer program comprising instructions, which, when executed by an apparatus, cause the apparatus at least to: generate, at a terminal device, a subscription concealed identifier, SUCI, of the terminal device based on a subscription permanent identifier, SUPI, of the terminal device, wherein the SUCI comprises a SUPI type indicating that both elliptic curve cryptography, ECC, and post quantum cryptography, PQC are used in the generating of the SUCI; and transmit, to a network device, the SUCI.

In a ninth aspect, there is provided a computer program comprising instructions, which, when executed by an apparatus, cause the apparatus at least to: receive, at a network device and from a terminal device, a subscription concealed identifier, SUCI, for concealing a subscription permanent identifier, SUPI, for the terminal device, wherein the SUCI comprises a SUPI type indicating that both elliptic curve cryptography, ECC, and post quantum cryptography, PQC are used in generating of the SUCI; and determine the SUPI by decrypting the SUCI.

In a tenth aspect, there is provided a terminal device comprising: generating circuitry configured to generate, a subscription concealed identifier, SUCI, of the terminal device based on a subscription permanent identifier, SUPI, of the terminal device, wherein the SUCI comprises a SUPI type indicating that both elliptic curve cryptography, ECC, and post quantum cryptography, PQC are used in the generating of the SUCI; and transmitting circuitry configured to transmit, to a network device, the SUCI.

In an eleventh aspect, there is provided a network device comprising: receiving circuitry configured to receive, from a terminal device, a subscription concealed identifier, SUCI, for concealing a subscription permanent identifier, SUPI, for the terminal device, wherein the SUCI comprises a SUPI type indicating that both elliptic curve cryptography, ECC, and post quantum cryptography, PQC are used in generating of the SUCI; and determining circuitry configured to determine the SUPI by decrypting the SUCI.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example communication system in which embodiments of the present disclosure may be implemented;

FIG. 1B illustrates encryption steps at UE side according to the ECIES scheme;

FIG. 1C illustrates decryption steps at network side according to the ECIES scheme;

FIG. 1D illustrates the SUPI defined in 3GPP TS 23.501;

FIG. 1E illustrates the SUCI according to the current specification;

FIG. 1F illustrates a scheme output for the ECIES scheme;

FIG. 2 illustrates an example of a process for SUCI encryption and decryption according to some embodiments of the present disclosure;

FIG. 3 illustrates an example of a SUPI and a SUCI according to some embodiments of the present disclosure;

FIG. 4 illustrates an example of a process of SUCI encryption based on hybrid key exchange at a terminal device according to some embodiments of the present disclosure;

FIG. 5 illustrates an example of a process of SUCI decryption based on hybrid key exchange at a network device according to some embodiments of the present disclosure;

FIG. 6 illustrates a flowchart of a method implemented at a terminal device according to some embodiments of the present disclosure;

FIG. 7 illustrates a flowchart of a method implemented at a network device according to some embodiments of the present disclosure;

FIG. 8 illustrates a simplified block diagram of an apparatus that is suitable for implementing embodiments of the present disclosure; and

FIG. 9 illustrates a block diagram of an example computer readable medium in accordance with some embodiments of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

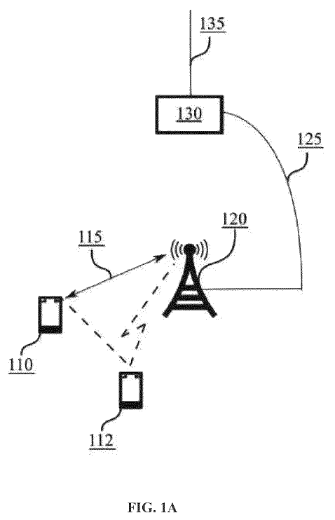

Reference is first made to FIG. 1A, which illustrates an example of communication system in which some example embodiments of the present disclosure may be implemented. According to the example scenario of FIG. 1A, there is a cellular communication system, which comprises first and second UE 110, 112, one or more base stations (BSs) 120, and a core network 130. The first UE 110 is connected to the BS 120 via an air interface 115. The BS 120 may be connected, directly or via at least one intermediate node, with the core network 130 via the interface 125. The core network 130 may be, in turn, coupled via the interface 135 with another network (not shown in FIG. 1A), via which connectivity to further networks may be obtained, for example via a worldwide interconnection network. In case of 4G, the core network 130 may be referred to as an Evolved Packet Core (EPC), and in case of 5G, the core network 130 may be referred to as a 5G Core (5GC). In any case, embodiments of the present disclosure are not restricted to any particular cellular communication technology.

The core network 130 may comprise more than one public land mobile network (PLMN), each equipped with at least one network function (NF). The NF may refer to an operational and/or a physical entity. The NF may be a specific network node or element, or a specific function or a set of functions carried out by one or more entities, such as a virtual NF. At least some example embodiments of the present disclosure may be applied in containerized or compartmentalized deployments as well. One physical node may be configured to perform tasks of multiple NFs.

In a 5G network, the core network 130 may comprise a home subscriber function. Examples of the home subscriber function may comprise a Unified Data Management (UDM) function, an Authentication Server Function (AUSF), a Network Slice Selection Function (NSSF), a Network Exposure Function (NEF), a Network Repository Function (NRF), a Policy Control Function (PCF), and an Application Function (AF).

The UDM function may comprise an authentication credential repository and processing function (ARPF) and a subscription identifier de-concealing function (SIDF). The SIDF may be responsible for resolving the SUPI from the SUCI, and the ARPF may contain the subscriber's credentials.

It is to be appreciated that this particular arrangement of system elements is an example only, and other types and arrangements of additional or alternative elements can be used to implement a communication system in other embodiments.

Communications in the communication system may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In FIG. 1A, the first UE 110 or a subscription module hosted by the first UE 110 may be the legitimate subscriber while the second UE 112 may be the attacker. For example, as an attacker, the second UE 112 may steal the identifier of the first UE 110 to perform communications, which is not desired.

As mentioned above, in the 5G System a SUPI may be allocated to each subscriber and a SUCI may be generated for concealing the SUPI for communication privacy preserving. Traditionally, the concealment of the SUPI is based on the ECIES scheme and the use of ECIES for concealment of the SUPI may adhere to efficient cryptography group (SECG) specifications.

FIG. 1B illustrates encryption steps at UE side according to the ECIES scheme. The ECIES scheme may be implemented such that for computing a fresh SUCI. The UE may use the provisioned public key of the home network and a freshly generated ECC ephemeral public/private key pair according to the ECIES parameters provisioned by the home network. The processing on UE side may be done according to encryption operations, which comprises: generating keying data K of length ‘enckeylen+icblen+mackeylen’; parsing the leftmost enckeylen octets of K as an encryption key (EK), the middle icblen octets of K as an initial counter block (ICB), and the rightmost mackeylen octets of K as a message authentication code (MAC) key (MK). The final output of the ECIES concealment scheme may be the concatenation of the ECC ephemeral public key, the ciphertext value, the MAC tag value, and any other parameters, if applicable.

FIG. 1C illustrates, according to the ECIES scheme, decryption steps at home network side, specifically, at an NF in the core network, such as SIDF. The ECIES scheme may be implemented such that for de-concealing a SUCI. The home network may use the received ECC ephemeral public key of the UE and a private key of the home network for the UE. The processing on home network side may be done according to decryption operations, which comprises: generating keying data K of length ‘enckeylen+icblen+mackeylen’; parsing the leftmost enckeylen octets of K as a decryption key (DK), the middle icblen octets of K as an ICB, and the rightmost mackeylen octets of K as a MAC key (MK). It is noted that unlike the UE, the home network does not need to perform a fresh ephemeral key pair generation for each decryption. How often the home network generates new public/private key pair and how the public key is provisioned to the UE are out of the scope of the present disclosure.

FIG. 1D illustrates the SUPI defined in 3GPP TS 23.501; FIG. 1E illustrates the SUCI according to the current specification; and FIG. 1F illustrates the scheme output for the ECIES scheme. As defined in the current 3GPP specification, the SUPI may comprise a value indicating a SUPI type. The SUPI type may indicate an international mobile subscriber identity (IMSI), a network specific identifier (NSI), a global line identifier (GLI) or a global cable identifier (GCI). Dependent on the value of the SUPI type, the SUPI may comprise a field indicating the corresponding IMSI, NSI, GLI or GCI.

Moreover, the SUPI type may take different formats depending on the protocol used to convey the SUPI. For 3GPP radio access technologies (RATs), a valid SUPI may consist of a mobile country code (MCC), a mobile network code (MNC) and a mobile subscription identification number (MSIN) as defined in 3GPP TS 23.003. For non-3GPP RATs, a valid SUPI may consist of a network access identifier (NAI) as defined in RFC 4282. The NAI may take different forms to define the NSI, GLI or GCI.

The SUCI may be generated by concealing at least part of the SUPI, for example, the MSIN part. As illustrated in FIG. 1E, the ECIES-based SUCI may be composed of the following parts. A first part is SUPI Type, consisting in a value in the range 0 to 7. It identifies the type of the SUPI concealed in the SUCI. The following values are defined: 0 for IMSI, 1 for NSI, 2 for GLI, 3 for GCI, 4 to 7 for spare values for future use.

A second part is Home Network Identifier, identifying the home network of the subscriber. A third part is Routing Indicator, consisting of 1 to 4 decimal digits assigned by the home network operator and provisioned in the USIM. A fourth part is Protection Scheme Identifier, consisting in a value in the range of 0 to 15 (see Annex C.1 of 3GPP TS 33.501). It represents the null scheme, or a non-null scheme specified in Annex C of 3GPP TS 33.501, or a protection scheme specified by the HPLMN. A fifth part is Home Network Public Key Identifier, consisting in a value in the range 0 to 255. It represents a public key provisioned by the HPLMN or SNPN and it is used to identify the key used for SUPI protection. A sixth part is Scheme Output, consisting of a string of characters with a variable length or hexadecimal digits, dependent on the used protection scheme. It represents the output of a public key protection scheme specified in Annex C of 3GPP TS 33.501 or the output of a protection scheme specified by the HPLMN. FIG. 1F illustrates an example scheme output. Other formats of the scheme output can be referenced in 3GPP TS 23.003. As discussed with reference to FIG. 1B, the scheme output may comprise an ECC ephemeral public key, a ciphertext value and a MAC tag value.

By concealing the SUPI and transmitting the SUCI containing the concealed SUPI, communication privacy may be achieved over the air radio interface. However, the traditional ECIES-based SUCI encryption will fall to quantum cryptanalysis. From 3GPP point of view, Cryptographically Relevant Quantum Computer (CRQC) poses a threat of an attacker using the home network's public key and Shor's algorithm to easily get the SUPI from the SUCI. So, it would render the encryption scheme vulnerable as the whole concept is based on someone not being able to crack the home network private key from the home network public key.

Meanwhile, migration to post-quantum cryptography (PQC) is unique in the history of modern digital cryptography in that neither the traditional algorithms nor the post-quantum algorithms are fully trusted to protect data for the required data lifetimes. The post-quantum algorithms may face uncertainty about underlying mathematics, compliance issues, unknown vulnerabilities, hardware, and software implementations that have not had sufficient maturing time to rule out classical cryptanalytic attacks and implementation bugs. Thus, during the transition from traditional to post-quantum algorithms, there is a desire or a requirement for protocols that use both algorithm types.

According to embodiments of the present disclosure, there is provided a solution for SUCI encryption based on hybrid cryptography. In some embodiments, a terminal device generates a SUCI of the terminal device based on a SUPI of the terminal device, wherein the SUCI comprises a SUPI type indicating that both ECC and PQC are used in the generating of the SUCI. The terminal device further transmits the SUCI to a network device.

In this way, the SUCI generated based on both ECC and PQC (also referred to as hybrid SUCI or new SUCI or SUCI-E (SUCI-Extension) herein) can avoid different kinds of attack, like Shor's algorithm attack on asymmetric cryptography methods based on prime factorization or discrete logarithm problem (finite field or elliptic curve). For example, the ECIES-based SUCI encryption uses elliptic curves based on the discrete logarithm problem, which makes it vulnerable to quantum cryptanalysis. In this event, an adversary may collect the home network public key and leveraging a CRQC to gain access to the home network private key. If the adversary gains access to the home network private, it makes it straightforward to break the SUCI encryption to get the SUPI. Consequently, with both the ECC and PQC, the hybrid SUCI can ensure security against the adversary with the intention of launching the Shor's attack.

Principles and embodiments of the present disclosure will be described in detail below with reference to the accompanying drawings. However, it is to be noted that these embodiments are illustrated as examples and not intended to limit scope of the present application in any way.

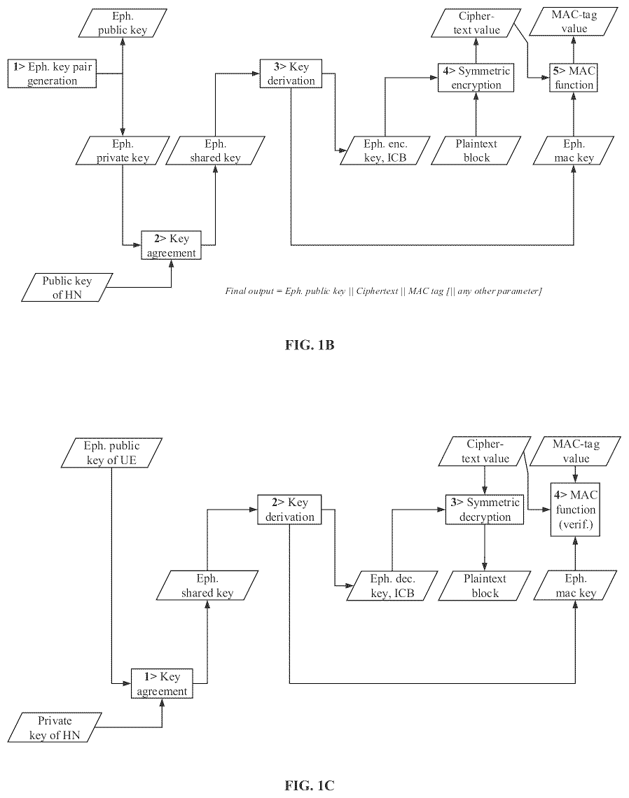

Reference is now made to FIG. 2, which shows an example of a process 200 for SUCI encryption according to an embodiment of the present disclosure. For the purpose of discussion, the process 200 will be described with reference to FIG. 1A.

As illustrated in FIG. 2, a terminal device 201 and a network device 202 may be involved in the process 200. The terminal device 201 may be an example of the UE 110 in FIG. 1A and the network device 202 may be an example of one or more elements of the core network 130. The terminal device 201 or a subscription module hosted by the terminal device 201 may be allocated a globally unique subscription identifier, i.e., a SUPI. The network device 202 may refer to a network entity responsible for de-concealing of a SUCI, i.e., determining the SUPI by decrypting the SUCI. For example, the network device 202 may be the SIDF, ARPF, or the UDM as discussed with reference to FIG. 1A.

In the process 200, the terminal device 201 generates 210 a SUCI of the terminal device 201 based on a SUPI of the terminal device 201. The SUCI comprises a SUPI type indicating that both ECC and PQC are used in the generating of the SUCI.

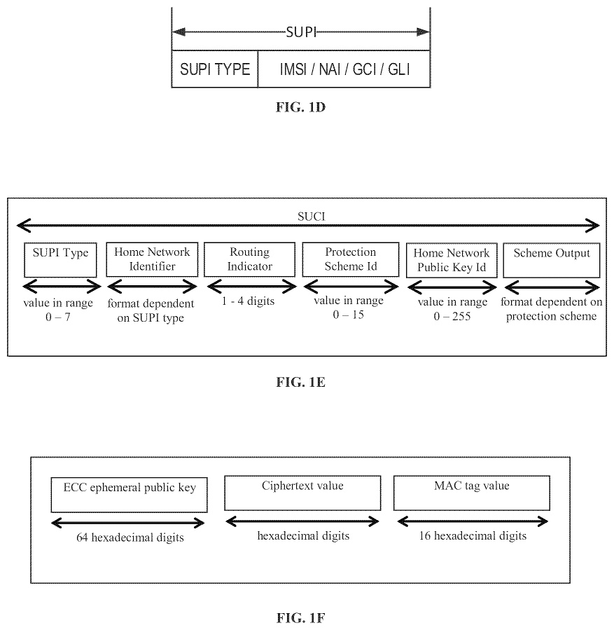

In some embodiments, the SUPI may be defined as in 3GPP TS 23.501. FIG. 3 illustrates an example of a SUPI 310 according to some embodiments of the present disclosure. As shown in FIG. 3, the SUPI 310 may comprise a field of the SUPI type and a field of IMSI, NSI, GLI, or GCI. The SUPI type may consist in a value in the range 0 to 7 and it identifies the type of the SUPI. A value of 0 may indicate that the type of SUPI is IMSI, a value of 1 may indicate that the type of SUPI is NSI, a value of 2 may indicate that the type of SUPI is GLI, a value of 3 may indicate that the type of SUPI is GCI, and values of 4 to 7 may be spare values for future use. Alternatively, or additionally, the SUPI may be defined in any suitable way to uniquely identify the subscriber for the terminal device 201.

FIG. 3 further illustrates an example of a SUCI 320 according to some embodiments of the present disclosure. As illustrated in FIG. 3, the SUCI 320 comprises a field of SUPI type. In some embodiments, the SUPI type in the SUCI 320 may consist in a value in the ranges 0 to 7 and the value may identify the type of the SUPI concealed in the SUCI.

In some embodiments, a value of 0 may indicate that the type of SUPI is IMSI; a value of 1 may indicate that the type of SUPI is NSI; a value of 2 may indicate that the type of SUPI is GLI; and a value of 3 may indicate that the type of SUPI is GCI. Notably, a value of 4 may indicate that both the ECC and PQC are used in the generating of the SUCI 320. Values of 5 to 7 may be spare values for future use.

Alternatively or additionally, the SUCI may be defined in any suitable way to indicate that both the ECC and PQC are used in the generating of the SUCI 320. For example, a value of any of 5 to 7 may indicate that both the ECC and the PQC are used in the generating of the SUCI 320.

In this way, a SUCI can be defined to comprise a SUPI type indicating that both the ECC and PQC are used in generating of the SUCI. Moreover, both of a new SUCI type (with the value of e.g., 4) or the old SUCI type (with the value of e.g., 0, 1, 2 or 3) can be support and will be helpful during the migration to PQC. Moreover, the SUCI type may be readable to any NF (like UDM) and thus the de-concealing of the SUCI can be applied accordingly via the ARPF.

In some embodiments, the SUCI 320 may further comprise a home network public key identifier (ID) associated with a traditional key encapsulation mechanism (KEM) and a home network public key identifier associated with the PQC KEM. For example, the SUCI 320 may comprise an ECC home network public key identifier (also referred to as ECC public key identifier for short) and a PQC KEM home network public key identifier (also referred to as PQC public key identifier for short). The home network for the terminal device 201 may comprise a home public land mobile network (HPLMN) or a stand-alone non-public network (SNPN).

In some embodiments, the ECC public key identifier may consist in a value in the range 0 to 255. The ECC public key identifier may indicate an ECC public key provisioned by the home network for the terminal device 201. The value of the ECC public key identifier may be set to 0 if and only if null protection scheme is used.

In some embodiments, the PQC public key identifier may consist in a value in the range 0 to 255. The PQC public key identifier may indicate a PQC KEM public key provisioned by the home network for the terminal device 201. As used in PQC, examples of the PQC KEM public key may comprise Kyber, bit flipping key encapsulation (BIKE), Hamming Quasi-Cyclic (HQC), and classic McEliece. The PQC KEM public key may be different from the ECC public key. The PQC KEM public key may be used to identify the key used for SUPI protection apart from the traditional home network public key (e.g., ECC public key).

In some embodiments, the SUCI 320 may further comprise a field of scheme output. The scheme output may be a cryptographically generated part of the SUCI 320 and it can be used for determining the SUPI from the SUCI 320. The scheme output may consist of a string of characters with a variable length or hexadecimal digits, dependent on the used protection scheme, as defined below. The scheme output may represent the output of a public key protection scheme according to some embodiments of the present disclosure.

In some embodiments, the field of scheme output may comprise an ECC ephemeral public key, a PQC KEM ciphertext value, a second ciphertext value, and a MAC-tag value. The PQC KEM ciphertext value may refer to PQC KEM ciphertext which is generated by PQC KEM using the PQC KEM public key of the home network. The second ciphertext may refer to a ciphertext value generated by both the ECC and PQC KEM. The scheme output may be the concatenation of the above values. The scheme output may comprise any other suitable parameters, if applicable.

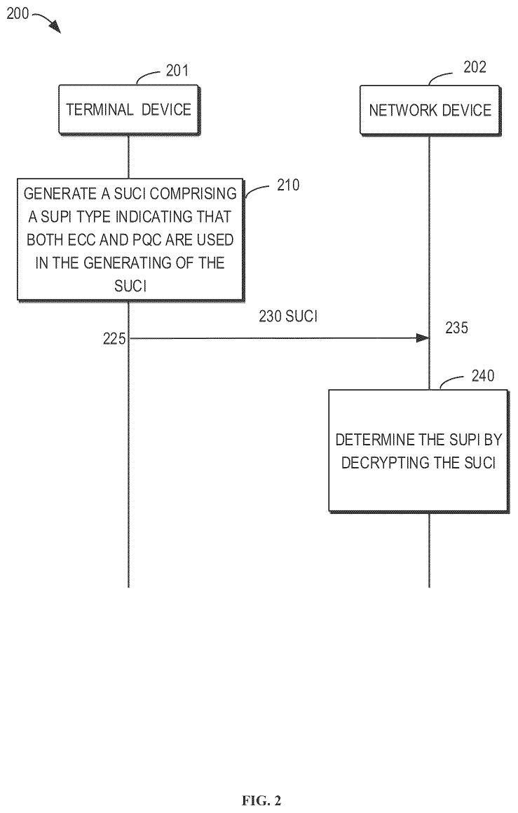

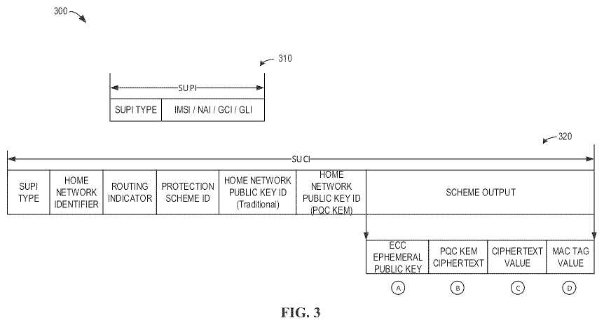

As illustrated in FIG. 3, the ECC ephemeral public key may be denoted by the marker ‘A’, the PQC KEM ciphertext may be denoted by the marker ‘B’, the second ciphertext value may be denoted by the marker ‘C’ and the MAC-tag value may be denoted by the marker ‘D’. Details of the scheme output generation may be described hereafter with reference to FIG. 4 and FIG. 5. Note that parameters like the PQC KEM ciphertext and the PQC home network public identifier may be added in the UE or USIM and verified in UDM.

In some embodiments, the SUCI 320 may further comprise a field of home network identifier identifying the home network of the subscriber for the terminal device 201. When the SUCI type is an IMSI, the home network identifier may comprise a MCC and a MNC. The MCC may consist of three decimal digits and identify uniquely the country of domicile of the mobile subscription. The MNC may consist of two or three decimal digits and identify the home PLMN or SNPN of the mobile subscription.

When the SUPI type is a NSI, a GLI or a GCI, the home network identifier may consist of a string of characters with a variable length representing a domain name as specified in clause 2.2 of IETF RFC 7542. For a GLI or a GCI, the domain name may correspond to the realm part specified in the NAI format for SUPI in clauses 28.15.2 and 28.16.2 of 3GPP TS 23.003.

In some embodiments, the SUCI 320 may further comprise a field of routing indicator. The routing indicator may consist of 1 to 4 decimal digits assigned by the home network operator and provisioned in the universal subscriber identity module (USIM), that allow together with the home network identifier to route network signaling with SUCI to AUSF and UDM instances capable to serve the subscriber. Each decimal digit present in the routing indicator may be regarded as meaningful (e.g., value “012” is not the same as value “12”). If no routing indicator is configured on the USIM, this data field may be set to the value 0 (i.e., only consist of one decimal digit of “0”).

In some embodiments, the SUCI 320 may further comprise a field of protection scheme identifier. The protection scheme identifier may consist in a value in the range of 0 to 15 (see Annex C.1 of 3GPP TS 33.501). It may represent the null scheme, or a non-null scheme specified in Annex C of 3GPP TS 33.501, or a protection scheme specified by the HPLMN. The null scheme may be used if the SUPI type is a GLI or GCI.

Referring back to FIG. 2, the terminal device 201 transmits 225 the generated SUCI 230 (e.g., SUCI 320 as illustrated in FIG. 3) to the network device 202. The network device 202 receives 235 the SUCI 230 and determines 240 the SUPI by decrypting the SUCI 230. As mentioned above, the de-concealment of the SUCI 230 may be performed by the SIDF, ARPF or UDM.

With the process 200, a new SUCI comprising a SUPI type indicating that both the ECC and PQC are used in the generating of the SUCI can be defined. With both of the ECC and PQC, the new SUCI can avoid different kinds of attack. For example, if the traditional ECC algorithm is broken by CRQC using the Shor's algorithm, the new SUCI can still ensure security against the adversary with the intention of launching Shor's attack due to the PQC used in the generating of the new SUCI.

FIG. 4 illustrates an example of a process 400 of SUCI encryption based on hybrid key exchange at a terminal device according to some embodiments of the present disclosure. For the purpose of discussion, the process 400 will be described with reference to FIG. 2. The process 400 may be performed by the terminal device 201.

As illustrated in FIG. 4, at UE side, a PQC KEM public key of home network (HN) (see step 1b) may be used in the key encapsulation mechanism to generate the PQC KEM ciphertext (‘B’, also referred to as PQC KEM ciphertext value) and a shared secret (ss). This shared secret may be used along with a traditional ECC ephemeral shared key in a key combiner function to generate the combined encryption key to generate the ciphertext value (‘C’) of SUPI and the MAC-tag value (‘D’).

Specifically, as illustrated by steps 1a, 2a and 3a, the terminal device 201 may generate a key pair (ECC ephemeral public key (‘A’) and private key) using key pair generation primitive. The terminal device 201 may determine an ECC ephemeral shared key based on the ECC ephemeral private key and an HN public key, i.e., a public key of the HPLMN or the SNPN. In some embodiments, based on the Diffie-Hellman primitive, an ECC ephemeral shared secret key element may be derived (from the public key of HN and the generated ephemeral private key).

As illustrated by steps 1b, 2b and 3b, the terminal device 201 may further determine the PQC KEM ciphertext value (‘B’) and the PQC shared secret based on the PQC KEM public key. For example, the PQC KEM ciphertext (ct) may be generated using the key encapsulation mechanism (asymmetric cryptographic scheme) where PK is the PQC KEM public key of HN. A PQC shared secret (ss) may also be generated and used as an input to a key derivation function (KDF) to derive the final PQC shared secret.

In some embodiments, the terminal device 201 may further update the final PQC shared secret to achieve properties of Fujisaki-Okamoto (FO) transform or its variant HHK (Hofheinz, Hövelmanns and Kiltz) by leveraging a key derivation function (KDF). The FO transform may be performed using the KDF such that the PQC KEM shared secret achieved is indistinguishability under adaptive chosen ciphertext attack (IND-CCA2) secure. In other words, the FO transform or its variant HHK may be applied on the PQC KEM part to ensure that the overall scheme is IND-CCA2 secure when the traditional part is broken.

In this case, without the presence of ephemeral keys (whenever traditional keys are broken) one can re-use the PQC KEM keys for a number of times less than a predetermined threshold number (but not recommended). The PQC KEM keys may be re-used for a number of times depending on some upper bound level. The upper bound level will be defined on how many times the KEM public key can be used, and the exact number needs not be specified in this disclosure.

As illustrated by step 4, the terminal device 201 may determine keying data based on a combination of the PQC shared secret and the ECC ephemeral shared key. The keying data may comprise an ephemeral encryption key (EK) and an initial counter block (ICB). The key combiner function may be used to combine the traditional shared key and newly generated final PQC shared secret (from the KDF function) to generate the keying data K of length ‘ephemeral Key (EK)+Initial counter block (ICB)’.

Then at step 5, the terminal device 201 may determine the ciphertext value (‘C’, also referred to as second ciphertext value to differ from the PQC KEM ciphertext) and the MAC tag value (‘D’) based on the SUPI, the EK and the ICB. In some embodiments, the terminal device 201 may determine the ciphertext value (‘C’) and the MAC-tag value (‘D’) by using authenticated encryption with associated data (AEAD) symmetric encryption. In other words, with the derived keys EK and ICB, AEAD may be performed to encrypt the plaintext block (SUPI) to generate the ciphered text (‘C’) and the MAC key (‘D’).

Based on the determined ECC ephemeral public key (‘A’), the PQC KEM ciphertext value (‘B’), the second ciphertext value (‘C’) and the MAC tag value (‘D’), the terminal device 201 may determine the scheme output and thereby generating the SUCI containing the concealed SUPI.

FIG. 5 illustrates an example of a process 500 of SUCI decryption based on hybrid key exchange at a network device according to some embodiments of the present disclosure. For the purpose of discussion, the process 500 will be described with reference to FIG. 2. The process 500 may be performed by the network device 202, e.g., the SIDF, UDM or ARPF.

As illustrated in FIG. 5, at steps 1a and 2a, the network device 202 may determine a ECC ephemeral shared key based on the ECC ephemeral public key (‘A’) and a private key of the HPLMN or the SNPN. For example, at SIDF side, the received UE ephemeral public key (‘A’) and the private key of home network may be used to generate the ephemeral shared key.

At step 1b, the network device 202 may identify a PQC KEM secret key of the HPLMN or the SNPN from the PQC public key identifier. For example, the SIDF may use the home network public key identifier (PQC KEM ID) to identify the PQC KEM secret of HN for decapsulation mechanism. Further, the network device 202 may determine a PQC shared secret, based on the PQC KEM ciphertext value (‘B’) and the PQC KEM secret key (sk). The PQC KEM ciphertext (ct) may be used along with the PQC KEM secret key of HN in key decapsulation mechanism (asymmetric cryptographic scheme) to generate the shared secret. At step 2b, the generated shared secret may be used as an input to the KDF function and to derive the final PQC shared secret.

At step 3, the network device 202 may determine keying data based on a combination of the PQC shared secret and the ECC ephemeral shared key, and the keying data may comprise an ephemeral decryption key (DK) and an initial counter block (ICB). In other words, the newly generated shared secret may be used along with the traditional ephemeral shared key as inputs to the key combiner function to generate the keying data K of length ‘Ephemeral decryption Key (DK)+Initial counter block (ICB)’.

Then at step 4, the network device 202 may determine the SUPI based on the second ciphertext value (‘C’), the DK and the ICB. In some embodiments, the network device 202 may determine the plaintext block (i.e., SUPI) by using AEAD symmetric decryption. The generated DK and ICB may be used to de-cipher the ciphertext value (‘C’) using the AEAD symmetric decryption.

Additionally, at step 5, the network device 202 may compare the MAC tag value to an expected MAC; and verify integrity of the SUCI based on the comparison. In other words, the received MAC tag value (‘D’) may be compared against the expected MAC, and with this comparison the integrity of the SUCI can be verified.

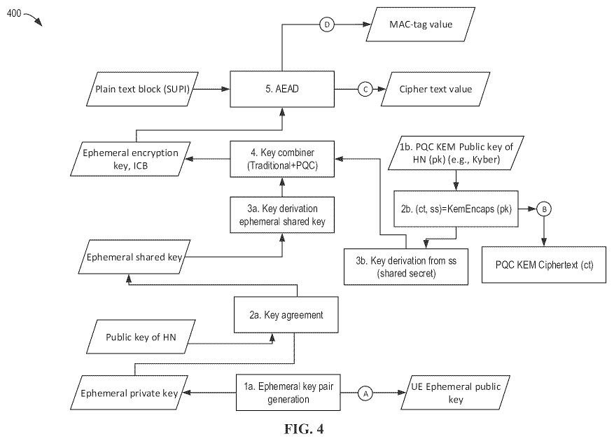

FIG. 6 illustrates a flowchart of an example method 600 implemented at a terminal device in accordance with some embodiments of the present disclosure. For the purpose of discussion, the method 600 will be described from the perspective of the terminal device 201 with reference to FIG. 2.

At block 610, a terminal device generates a SUCI of the terminal device based on a SUPI of the terminal device, wherein the SUCI comprises a SUPI type indicating that both ECC and PQC are used in the generating of the SUCI. At block 620, the terminal device transmits the SUCI to a network device.

In some embodiments, the SUCI may comprise an ECC public key identifier and a PQC public key identifier, and wherein the ECC public key identifier indicates an ECC public key provisioned by a home public land mobile network, HPLMN, or a stand-alone non-public network, SNPN for the terminal device, and the PQC public key identifier indicates a PQC KEM public key provisioned by the HPLMN or the SNPN.

In some embodiments, the SUCI may further comprise a field of scheme output and the field of scheme output may comprise an ECC ephemeral public key, a PQC KEM ciphertext value, a second ciphertext value and a message authentication code, MAC, tag value.

In some embodiments, the terminal device may determine the SUCI by: determining an ECC ephemeral shared key based on an ECC ephemeral private key and a public key of the HPLMN or the SNPN; determining the PQC KEM ciphertext value and a PQC shared secret based on the PQC KEM public key; determining keying data based on a combination of the PQC shared secret and the ECC ephemeral shared key, wherein the keying data comprises an ephemeral encryption key, EK, and an initial counter block, ICB; determining the second ciphertext value and the MAC tag value based on the SUPI, the EK and the ICB; and determining the scheme output based on the ECC ephemeral public key, the PQC KEM ciphertext value, the second ciphertext value and the MAC tag value.

In some embodiments, the terminal device may determine the second ciphertext value and the MAC tag value based on the SUPI, the EK and the ICB by using authenticated encryption with associated data, AEAD, symmetric encryption.

In some embodiments, the terminal device may further derive a second PQC shared secret from the PQC shared secret; and update the second PQC shared secret to achieve properties of Fujisaki-Okamoto (FO) transform or its variant HHK by leveraging a KDF, wherein the updated second PQC shared secret is IND-CCA2 secure.

In some embodiments, a value of the SUPI type may be 4. In some embodiments, the PQC KEM public key may be one of Kyber, BIKE, Hamming Quasi-Cyclic, or classic McEliece. In some embodiments, the PQC KEM public key may re-used for a number of times less than a predetermined threshold number.

In some embodiments, an apparatus capable of performing any of the method 600 (for example, the terminal device 201) may comprise means for performing the respective steps of the method 600. The means may be implemented in any suitable form. For example, the means may be implemented in a circuitry or software module.

In some embodiments, the apparatus comprises: means for generating, at a terminal device, a SUCI of the terminal device based on a SUPI of the terminal device, wherein the SUCI comprises a SUPI type indicating that both ECC and PQC are used in the generating of the SUCI; and means for transmitting, at the terminal device, the SUCI to a network device.

In some embodiments, the SUCI may comprise an ECC public key identifier and a PQC public key identifier, and wherein the ECC public key identifier indicates an ECC public key provisioned by a home public land mobile network, HPLMN, or a stand-alone non-public network, SNPN for the terminal device, and the PQC public key identifier indicates a PQC KEM public key provisioned by the HPLMN or the SNPN.

In some embodiments, the SUCI may further comprise a field of scheme output and the field of scheme output may comprise an ECC ephemeral public key, a PQC KEM ciphertext value, a second ciphertext value and a message authentication code, MAC, tag value.

In some embodiments, the means for determining the SUCI may comprise: means for determining an ECC ephemeral shared key based on an ECC ephemeral private key and a public key of the HPLMN or the SNPN; means for determining the PQC KEM ciphertext value and a PQC shared secret based on the PQC KEM public key; means for determining keying data based on a combination of the PQC shared secret and the ECC ephemeral shared key, wherein the keying data comprises an ephemeral encryption key, EK, and an initial counter block, ICB; means for determining the second ciphertext value and the MAC tag value based on the SUPI, the EK and the ICB; and means for determining the scheme output based on the ECC ephemeral public key, the PQC KEM ciphertext value, the second ciphertext value and the MAC tag value.

In some embodiments, the means for determining the second ciphertext value and the MAC tag value based on the SUPI, the EK and the ICB may comprise means for determining the second ciphertext value and the MAC tag value using authenticated encryption with associated data, AEAD, symmetric encryption.

In some embodiments, the apparatus may further comprise means for deriving a second PQC shared secret from the PQC shared secret; and means for updating the second PQC shared secret to achieve properties of Fujisaki-Okamoto (FO) transform or its variant HHK by leveraging a KDF, wherein the updated second PQC shared secret is IND-CCA2 secure.

In some embodiments, a value of the SUPI type may be 4. In some embodiments, the PQC KEM public key may be one of Kyber, BIKE, Hamming Quasi-Cyclic, or classic McEliece. In some embodiments, the PQC KEM public key may re-used for a number of times less than a predetermined threshold number.

In some embodiments, the apparatus further comprises means for performing other steps in some embodiments of the method 600. In some embodiments, the means comprises at least one processor; and at least one memory including computer program code, the at least one memory and computer program code configured to, with the at least one processor, cause the performance of the apparatus.

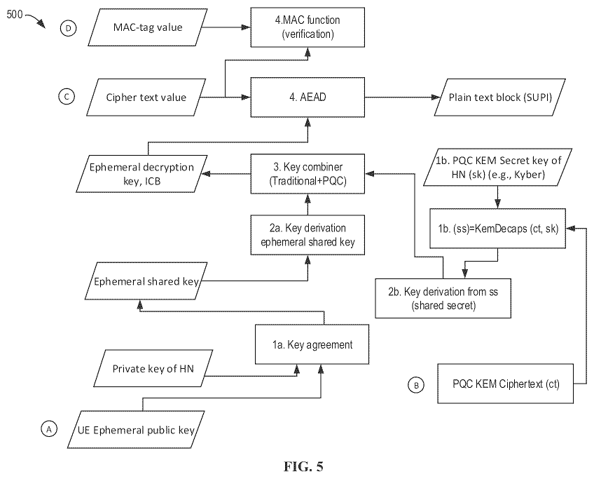

FIG. 7 illustrates a flowchart of an example method 700 implemented at a network device in accordance with some embodiments of the present disclosure. For the purpose of discussion, the method 700 will be described from the perspective of the network device 202 with reference to FIG. 2.

At block 710, a network device receives from a terminal device, a SUCI for concealing a SUPI for the terminal device, wherein the SUCI comprises a SUPI type indicating that both ECC and PQC are used in generating of the SUCI. At block 720, the network device determines the SUPI by decrypting the SUCI.

In some embodiments, the SUCI may further comprise an ECC public key identifier and a PQC public key identifier, and wherein the ECC public key identifier indicates an ECC public key provisioned by a home public land mobile network, HPLMN, or a stand-alone non-public network, SNPN for the terminal device, and the PQC public key identifier indicates a PQC key encapsulation mechanism, KEM, public key provisioned by the HPLMN or the SNPN.

In some embodiments, the SUCI may further comprise a scheme output and the scheme output comprises an ECC ephemeral public key, a PQC KEM ciphertext value, a second ciphertext value and a message authentication code, MAC, tag value.

In some embodiments, the network device may determine the SUPI by: determining an ECC ephemeral shared key based on the ECC ephemeral public key and a private key of the HPLMN or the SNPN; identifying a PQC KEM secret key of the HPLMN or the SNPN from the PQC public key identifier; determining a PQC shared secret, based on the PQC KEM ciphertext value and the PQC KEM secret key; determining keying data based on a combination of the PQC shared secret and the ECC ephemeral shared key, the keying data comprising an ephemeral decryption key, DK, and an initial counter block, ICB; and determining, the SUPI, based on the second ciphertext value, the DK and the ICB.

In some embodiments, the network device may determine, the SUPI, based on the second ciphertext value, the DK and the ICB by using AEAD, symmetric decryption.

In some embodiments, the network device may further compare the MAC tag value to an expected MAC; and verify integrity of the SUCI based on the comparison.

In some embodiments, a value of the SUPI type may be 4. In some embodiments, the PQC KEM secret key may be one of Kyber, BIKE, Hamming Quasi-Cyclic, or classic McEliece. In some embodiments, the network device may decrypt the SUCI at any of the following: a subscriber identity de-concealing function, SIDF, a unified data management, UDM, function, or an authentication credential repository and processing, ARPF, function.

In some embodiments, an apparatus capable of performing any of the method 700 (for example, the network device 202) may comprise means for performing the respective steps of the method 700. The means may be implemented in any suitable form. For example, the means may be implemented in a circuitry or software module.

In some embodiments, the apparatus comprises: means for receiving, at a network device and from a terminal device, a SUCI for concealing a SUPI for the terminal device, wherein the SUCI comprises a SUPI type indicating that both ECC and PQC are used in generating of the SUCI; and means for determining the SUPI by decrypting the SUCI.

In some embodiments, the SUCI may further comprise an ECC public key identifier and a PQC public key identifier, and wherein the ECC public key identifier indicates an ECC public key provisioned by a home public land mobile network, HPLMN, or a stand-alone non-public network, SNPN for the terminal device, and the PQC public key identifier indicates a PQC key encapsulation mechanism, KEM, public key provisioned by the HPLMN or the SNPN.

In some embodiments, the SUCI may further comprise a scheme output and the scheme output comprises an ECC ephemeral public key, a PQC KEM ciphertext value, a second ciphertext value and a message authentication code, MAC, tag value.

In some embodiments, the means for determining the SUPI may comprise: means for determining an ECC ephemeral shared key based on the ECC ephemeral public key and a private key of the HPLMN or the SNPN; means for identifying a PQC KEM secret key of the HPLMN or the SNPN from the PQC public key identifier; means for determining a PQC shared secret, based on the PQC KEM ciphertext value and the PQC KEM secret key; means for determining keying data based on a combination of the PQC shared secret and the ECC ephemeral shared key, the keying data comprising an ephemeral decryption key, DK, and an initial counter block, ICB; and means for determining, the SUPI, based on the second ciphertext value, the DK and the ICB.

In some embodiments, the means for determining the SUPI based on the second ciphertext value, the DK and the ICB may comprise means for determining the SUPI by using AEAD, symmetric decryption.

In some embodiments, the apparatus may further comprise means for comparing the MAC tag value to an expected MAC; and means for verifying integrity of the SUCI based on the comparison.

In some embodiments, a value of the SUPI type may be 4. In some embodiments, the PQC KEM secret key may be one of Kyber, BIKE, Hamming Quasi-Cyclic, or classic McEliece. In some embodiments, the means for decrypting the SUCI may comprise means for decrypting the SUCI at any of the following: a subscriber identity de-concealing function, SIDF, a unified data management, UDM, function, or an authentication credential repository and processing, ARPF, function.

In some embodiments, the apparatus further comprises means for performing other steps in some embodiments of the method 700. In some embodiments, the means comprises at least one processor; and at least one memory including computer program code, the at least one memory and computer program code configured to, with the at least one processor, cause the performance of the apparatus.

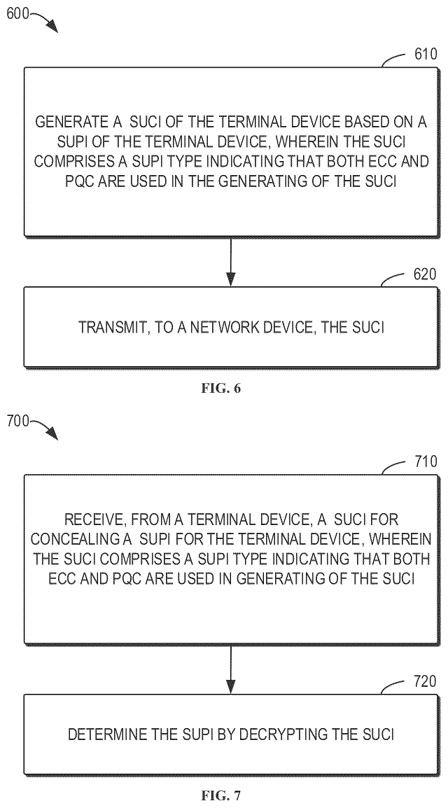

FIG. 8 is a simplified block diagram of a device 800 that is suitable for implementing embodiments of the present disclosure. The device 800 may be provided to implement the communication device, for example the terminal device 201 and the network device 202 as shown in FIG. 2. As shown, the device 800 includes one or more processors 810, one or more memories 840 coupled to the processor 810, and one or more communication modules 840 coupled to the processor 810.

The communication module 840 is for bidirectional communications. The communication module 840 has at least one antenna to facilitate communication. The communication interface may represent any interface that is necessary for communication with other network elements.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The program 830 may be stored in the ROM 824. The processor 810 may perform any suitable actions and processing by loading the program 830 into the RAM 822.

The embodiments of the present disclosure may be implemented by means of the program 830 so that the device 800 may perform any process of the disclosure as discussed with reference to FIGS. 2 to 7. The embodiments of the present disclosure may also be implemented by hardware or by a combination of software and hardware.

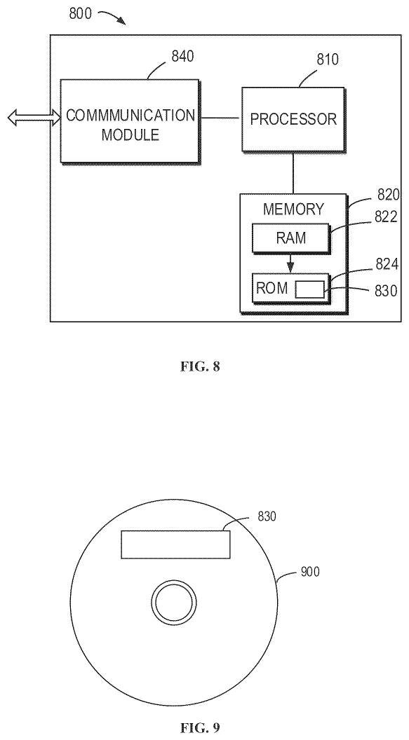

In some embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. The computer readable medium may include any types of tangible non-volatile storage, such as ROM, EPROM, a flash memory, a hard disk, CD, DVD, and the like. FIG. 9 shows an example of the computer readable medium 900 in form of CD or DVD. The computer readable medium has the program 830 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 600 or 700 as described above with reference to FIGS. 2-7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device comprising:
at least one processor; and
at least one memory storing instructions that, when executed by the at least one processor, cause the terminal device at least to:
generate, a subscription concealed identifier, SUCI, of the terminal device based on a subscription permanent identifier, SUPI, of the terminal device, wherein the SUCI comprises a SUPI type indicating that both elliptic curve cryptography, ECC, and post quantum cryptography, PQC are used in the generating of the SUCI; and
transmit, to a network device, the SUCI.

2. The terminal device of claim 1, wherein the SUCI comprises an ECC public key identifier and a PQC public key identifier, and
wherein the ECC public key identifier indicates an ECC public key provisioned by a home public land mobile network, HPLMN, or a stand-alone non-public network, SNPN for the terminal device, and the PQC public key identifier indicates a PQC key encapsulation mechanism, KEM, public key provisioned by the HPLMN or the SNPN.

3. The terminal device of claim 2, wherein the SUCI further comprises a field of scheme output and the field of scheme output comprises an ECC ephemeral public key, a PQC KEM ciphertext value, a second ciphertext value and a message authentication code, MAC, tag value.

4. The terminal device of claim 3, wherein the terminal device is caused to determine the SUCI by:
determining an ECC ephemeral shared key based on an ECC ephemeral private key and a public key of the HPLMN or the SNPN;
determining the PQC KEM ciphertext value and a PQC shared secret based on the PQC KEM public key;
determining keying data based on a combination of the PQC shared secret and the ECC ephemeral shared key, wherein the keying data comprises an ephemeral encryption key, EK, and an initial counter block, ICB;
determining the second ciphertext value and the MAC tag value based on the SUPI, the EK and the ICB; and
determining the scheme output based on the ECC ephemeral public key, the PQC KEM ciphertext value, the second ciphertext value and the MAC tag value.

5. The terminal device of claim 4, wherein the terminal device is caused to determine the second ciphertext value and the MAC tag value based on the SUPI, the EK and the ICB by using authenticated encryption with associated data, AEAD, symmetric encryption.

6. The terminal device of claim 5, wherein the terminal device is further caused to:
derive a second PQC shared secret from the PQC shared secret; and
update the second PQC shared secret to achieve properties of Fujisaki-Okamoto (FO) transform or its variant HHK by leveraging a key derivation function, KDF, wherein the updated second PQC shared secret is IND-CCA2 secure.

7. The terminal device of claim 1, wherein a value of the SUPI type is 4.

8. The terminal device of claim 2, wherein the PQC KEM public key is one of Kyber, BIKE, Hamming Quasi-Cyclic, or classic McEliece.

9. The terminal device of claim 2, wherein the PQC KEM public key is re-used for a number of times less than a predetermined threshold number.

10. A network device comprising:
at least one processor; and
at least one memory storing instructions that, when executed by the at least one processor, cause the network device at least to:
receive, from a terminal device, a subscription concealed identifier, SUCI, for concealing a subscription permanent identifier, SUPI, for the terminal device, wherein the SUCI comprises a SUPI type indicating that both elliptic curve cryptography, ECC, and post quantum cryptography, PQC are used in generating of the SUCI; and
determine the SUPI by decrypting the SUCI.

11. The network device of claim 10, wherein the SUCI further comprises an ECC public key identifier and a PQC public key identifier, and
wherein the ECC public key identifier indicates an ECC public key provisioned by a home public land mobile network, HPLMN, or a stand-alone non-public network, SNPN for the terminal device, and the PQC public key identifier indicates a PQC key encapsulation mechanism, KEM, public key provisioned by the HPLMN or the SNPN.

12. The network device of claim 11, wherein the SUCI further comprises a scheme output and the scheme output comprises an ECC ephemeral public key, a PQC KEM ciphertext value, a second ciphertext value and a message authentication code, MAC, tag value.

13. The network device of claim 12, wherein the network device is caused to determine the SUPI by:
determining an ECC ephemeral shared key based on the ECC ephemeral public key and a private key of the HPLMN or the SNPN;
identifying a PQC KEM secret key of the HPLMN or the SNPN from the PQC public key identifier;
determining a PQC shared secret, based on the PQC KEM ciphertext value and the PQC KEM secret key;
determining keying data based on a combination of the PQC shared secret and the ECC ephemeral shared key, the keying data comprising an ephemeral decryption key, DK, and an initial counter block, ICB; and
determining, the SUPI, based on the second ciphertext value, the DK and the ICB.

14. The network device of claim 13, wherein the network device is caused to determine, the SUPI, based on the second ciphertext value, the DK and the ICB by using AEAD, symmetric decryption.

15. The network device of claim 12, wherein the network device is further caused to:
compare the MAC tag value to an expected MAC; and
verify integrity of the SUCI based on the comparison.

16. The network device of claim 10, wherein a value of the SUPI type is 4.

17. The network device of claim 13, wherein the PQC KEM secret key is one of Kyber, BIKE, Hamming Quasi-Cyclic, or classic McEliece.

18. The network device of claim 10, wherein the network device is caused to decrypt the SUCI at any of the following:
a subscriber identity de-concealing function, SIDF,
a unified data management, UDM, function, or
an authentication credential repository and processing, ARPF, function.

19. A method comprising:
generating, at a terminal device, a subscription concealed identifier, SUCI, of the terminal device based on a subscription permanent identifier, SUPI, of the terminal device, wherein the SUCI comprises a SUPI type indicating that both elliptic curve cryptography, ECC, and post quantum cryptography, PQC are used in the generating of the SUCI; and
transmitting, from the terminal device, the SUCI to a network device.

20. A method comprising:
receiving, at a network device and from a terminal device, a subscription concealed identifier, SUCI, for concealing a subscription permanent identifier, SUPI, for the terminal device, wherein the SUCI comprises a SUPI type indicating that both elliptic curve cryptography, ECC, and post quantum cryptography, PQC are used in generating of the SUCI; and
determining the SUPI by decrypting the SUCI.
